(19) United States
(12) Patent Application Publication
(10) Pub. No.: US 2006/0062262 A1
(43) Pub. Date: Mar. 23, 2006

(54) Tunable laser source

(75) Inventor: Hiroshi Kubota, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/227,064

(22) Filed: Sep. 16, 2005

(30) Foreign Application Priority Data
Sep. 17, 2004 (JP) P.2004-271407

(51) Int. Cl. H01S 3/10

(52) U.S. Cl. 372/20

(57) ABSTRACT

A tunable laser source has a semiconductor laser which outputs laser light over a predetermined wavelength range, a laser driving circuit which supplies a laser driving current to the semiconductor laser, a light receiving section which receives the laser light output from the semiconductor laser, a current control section which controls the laser driving current output from the laser driving circuit based on a light intensity of the laser light received by the light receiving section, and a branch section which branches the laser light output from the semiconductor laser to output one branched light as output light and output another branched light to the light receiving section. The branch section has wavelength characteristics of a branch ratio in the predetermined wavelength range where a light intensity ratio of the another branched light is smaller than a light intensity ratio of the laser light output from the semiconductor laser.

### CROSS-REFERENCE TO RELATED APPLICATIONS

This application is based upon and claims the benefit of priority from the prior Japanese Patent Applications No. 2004-271407, filed on Sep. 17, 2004, the entire contents of which are incorporated herein by reference.

### BACKGROUND OF THE INVENTION

1. Field of the Invention

The invention relates to a tunable laser source which is useful in optical communications, a measuring device for the optical communication, the other optical measuring devices, and which can vary the wavelength over a wide range. The invention particularly relates to a tunable laser source in which the light intensity of output light can be accurately adjusted.

2. Description of the Related Art

An external resonator type tunable laser source can vary the wavelength of output light over a wide range. Laser light of a semiconductor laser is monitored so that the light intensity of output light (also called the optical power) is a preset light intensity, and the light intensity of the output light is adjusted (For example, see JP-A-7-45890 and JP-A-2002-232075.).

FIG. 4 shows the configuration of an external resonator type tunable laser source as a related art (For example, see JP-A-7-45890.). With reference to FIG. 4, an external resonator type tunable laser source in a Littman arrangement will be described as an example. An optical amplifier 10 has a semiconductor laser 11, a first lens 12, and a second lens 13. The semiconductor laser 11 has an antireflection film 11a at one end. The first lens 12 converts light emitted from the one end (the end face where the antireflection film 11a is formed) of the semiconductor laser 11 to parallel light, and emits the parallel light. The second lens 13 converges laser light emitted from the other end of the semiconductor laser 11.

A wavelength selecting section 20 has a diffraction grating 21, a wavelength selecting mirror 22, and mirror rotating section 23, selects the wavelength of the light emitted from the one end of the optical amplifier 10, and feedbacks the selected light to the optical amplifier 10. The diffraction grating 21 wavelength-disperses the light from the optical amplifier 10 and that from the wavelength selecting mirror 22. The wavelength selecting mirror 22 is a reflecting means, and reflects the light wavelength-dispersed by the diffraction grating 21, to the diffraction grating 21. The mirror rotating section 23 rotates the wavelength selecting mirror 22 to select the wavelength of the light which is to be fed back by the diffraction grating 21 to the optical amplifier 10.

A laser driving circuit 30 outputs to the semiconductor laser 11 a laser driving current for driving the semiconductor laser 11. The laser light converged by the second lens 13 is incident on an optical coupler 40. The optical coupler branches the incident laser light to two light, and outputs one of the branched light as output light. A light receiving section 50 receives the other branched light which is branched by the optical coupler 40. A current control section 60 controls the value of the laser driving current output from the laser driving circuit 30, on the basis of the light intensity of the laser light (the other branched light) received by the light receiving section 50.

Next, the light receiving section 50 will be described. FIG. 5 shows the configuration of the light receiving section 50. Referring to FIG. 5, the light receiving section 50 has a photodiode 51, an operational amplifier 52, a resistor R, and an A/D converter 53, and outputs a voltage corresponding to the light intensity of the other branched light, i.e., at least one of digital data and analog data of the A/D converter 53.

The other branched light is incident on the photodiode 51. The operational amplifier 52 receives a photocurrent from the photodiode 51, and converts the current to a voltage. In the operational amplifier 52, a negative feedback loop is formed by the resistor R, and the gain is determined by the resistor R. Usually, the resistor R has a fixed value, and the gain is constant. This is conducted in order to prevent discontinuous data from being generated by switching of the gain, and the current control section 60 from producing an error. The A/D converter 53 converts an analog voltage output from the operational amplifier 52 to digital data.

The operation of the above light source will be described.

The laser driving circuit 30 supplies the laser driving current to the semiconductor laser 11. The light emitted from the one end of the semiconductor laser 11 by the current supply is converted to parallel light by the first lens 12, and then enters the diffraction grating 21. The light entering the diffraction grating 21 is diffracted by the diffraction grating 21, wavelength-dispersed to different angles depending on the wavelength, and then enters the wavelength selecting mirror 22. Among the light incident on the wavelength selecting mirror 22, only the light of a desired wavelength is reflected to the diffraction grating 21 through the same optical path. The wavelength to be reflected through the same optical path is selected by the mirror rotating section 23.

The light incident on the diffraction grating 21 is again wavelength-dispersed. Only the light of the wavelength selected by the wavelength selecting section 20 is converged in the semiconductor laser 11 by the first lens 12 to be fed back. The other end of the semiconductor laser 11, and the wavelength selecting mirror 22 form an external resonator, and perform laser oscillation.

On the other hand, the laser light emitted from the other end which is not provided with the antireflection film 11a is converged by the second lens 13, and then enters the optical coupler 40. The optical coupler 40 branches the laser light into two light. One of the branched light is output as the output light of the tunable laser source, and the other branched light is received by the light receiving section 50.

The photodiode 51 of the light receiving section 50 outputs a photocurrent which corresponds to the light intensity of the other branched light. The photocurrent is converted to a voltage by the operational amplifier 52 and the resistor R. The A/D converter 53 converts the analog data to digital data. The light receiving section 50 outputs at least one of the analog voltage value output from the operational amplifier 52, and the digital voltage value output from the A/D converter 53, to the current control section 60. On the bases of the voltage value output from the light receiving section 50, the current control section 60 obtains a current value at which the light intensity of the output light is a target value, and supplies the value to the laser driving circuit 30. As a result, the laser driving circuit 30 outputs the laser driving current of the obtained value to the semiconductor laser 11. Namely, the current control section 60 is an APC (Automatic Power Control).

The wavelength selecting mirror 22 is rotated by the mirror rotating section 23, whereby the wavelength of the light fed back from the wavelength selecting section 20 to the optical amplifier 10 is made variable, and a wavelength sweep of the output light is performed.

As described above, the current control section 60 controls the current value of the laser driving circuit 30 on the basis of the voltage value output from the light receiving section 50, whereby the light intensity is controlled to a desired value over the whole wavelength range, and light of a stabilized light intensity is output.

JP-A-7-45890 (paragraph Nos. 0002 to 0004, FIG. 2) and JP-A-2002-232075 (paragraph Nos. 0016 to 0038, FIG. 1) are referred to as related art.

Even when the laser driving current is constant, usually, the light intensity of the laser light of the semiconductor laser 11 is varied depending on the wavelength. FIG. 6 shows an example of the wavelength characteristics of the semiconductor laser 11. In FIG. 6, the abscissa indicates the wavelength, and the ordinate indicates the light intensity. At a wavelength λmax, the light intensity is at the maximum Pmax, and, at a wavelength λmin, the light intensity is at the minimum Pmin. In the vicinity of the wavelength λmax, the light intensity is flat, and, as advancing toward a shorter wavelength side and a longer wavelength side, the light intensity is rapidly attenuated.

Conventionally, the specification is determined while the vicinity of the wavelength λmax is set as a tunable range. Recently, however, the tunable range is further widened by request of the user, so that the light intensity ratio Δd of the maximum light intensity Pmax and the minimum light intensity Pmin is about 13 to 20 [dB].

On the other hand, the branch ratio of the optical coupler 40 is constant irrespective of the wavelength. Even when the absolute amount of the intensity of light incident on the light receiving section 50 is reduced, therefore, the light intensity ratio remains to be equal to the light intensity ratio Δd of the semiconductor laser 11. Consequently, the light receiving section 50 must have a very wide dynamic range.

The gain of the operational amplifier 52 of the light receiving section 50, and the intensity of light incident on the photodiode 51 are set so that the A/D converter 53 is not saturated even when a voltage corresponding to the maximum light intensity Pmax is input to the A/D converter 53.

However, the gain of the operational amplifier 52 is constant (the resistor R has a constant value). When the operational amplifier 52 is set so as not to be saturated at the maximum light intensity Pmax, therefore, the intensity of light incident on the photodiode 51 at the minimum light intensity Pmin is remarkably reduced, and buried by noises, thereby causing a problem in that the light receiving sensitivity is impaired and it is difficult to accurately receive light.

### SUMMARY OF THE INVENTION

An object of the invention is to provide a tunable laser source in which the light intensity of output light can be accurately adjusted.

The invention provides a tunable laser source, having: a semiconductor laser which outputs laser light over a predetermined wavelength range; a laser driving circuit which supplies a laser driving current to the semiconductor laser; a light receiving section which receives the laser light output from the semiconductor laser; a current control section which controls the laser driving current output from the laser driving circuit based on a light intensity of the laser light received by the light receiving section; and a branch section which branches the laser light output from the semiconductor laser to output one branched light as output light and output another branched light to the light receiving section, wherein the branch section has wavelength characteristics of a branch ratio in the predetermined wavelength range where a light intensity ratio of the another branched light is smaller than a light intensity ratio of the laser light output from the semiconductor laser.

The invention also provides a tunable laser source, having: a semiconductor laser which outputs laser light over a predetermined wavelength range; a laser driving circuit which supplies a laser driving current to the semiconductor laser; an optical attenuator which attenuates the laser light output from the semiconductor laser; a light receiving section which receives the laser light attenuated by the optical attenuator; an attenuation control section which controls attenuation by the optical attenuator based on a light intensity of the laser light received by the light receiving section; and a branch section which branches the laser light output from the optical attenuator to output one branched light as output light and output another branched light to the light receiving section, wherein the branch section has wavelength characteristics of a branch ratio in the predetermined wavelength range where a light intensity ratio of the another branched light is smaller than a light intensity ratio of the laser light output from the semiconductor laser.

In the tunable laser source, the branch section is an optical coupler, a beam splitter, or a half mirror.

In the tunable laser source, the semiconductor laser has wavelength characteristics of the light intensity of the laser light in the predetermined wavelength range where the light intensity decreases as a wavelength of the laser light shifts toward a shorter wavelength side and a longer wavelength side, and the branch section has wavelength characteristics of the branch ratio in the predetermined wavelength range where the light intensity of the another branched light increases as the wavelength of the wavelength of the laser light shifts toward the shorter wavelength side and the longer wavelength side, and where the light intensity ratio of the another branched light is smaller than a predetermined value.

According to the tunable laser source, since the branch ratio of the branch section is different depending on the wavelength, the light intensity ratio of the maximum light intensity and the minimum light intensity of the other branched light incident on the light receiving section is smaller than the light intensity ratio of the laser light incident on the branch section. As a result, the dynamic range required in the light receiving section can be reduced, and the intensity of the other branched light can be accurately measured. Therefore, the current control section can correctly obtain the laser driving current of the semiconductor laser, and can accurately adjust the intensity of the output light.

According to the tunable laser source, since the branch ratio of the branch section is different depending on the wavelength, the light intensity ratio of the maximum light intensity and the minimum light intensity of the other branched light incident on the light receiving section is smaller than the light intensity ratio of the laser light incident on the branch section via the optical attenuator. As a result, the dynamic range required in the light receiving section can be reduced, and the intensity of the other branched light can be accurately measured. Therefore, the attenuation control section can correctly obtain the degree of attenuation conducted by the optical attenuator, and can accurately adjust the intensity of the output light.

### BRIEF DESCRIPTION OF THE DRAWINGS

FIG. 1 is a diagram showing the configuration of a first embodiment of the invention;

FIGS. 2A and 2B are views showing wavelength characteristics of a branch ratio and other branched light of an optical coupler 70 of a light source shown in FIG. 1, and the intensity of incident laser light;

FIG. 3 is a diagram showing the configuration of a second embodiment of the invention;

FIG. 4 is a diagram showing the configuration of a tunable laser source as a related art;

FIG. 5 is a diagram showing the configuration of a light receiving section 50; and

FIG. 6 is a view showing wavelength characteristics of the intensity of laser light output from a semiconductor laser 11.

### DETAILED DESCRIPTION OF THE PREFERRED EMBODIMENTS

Embodiments of the invention will be described with reference to the accompanying drawings.

### First Embodiment

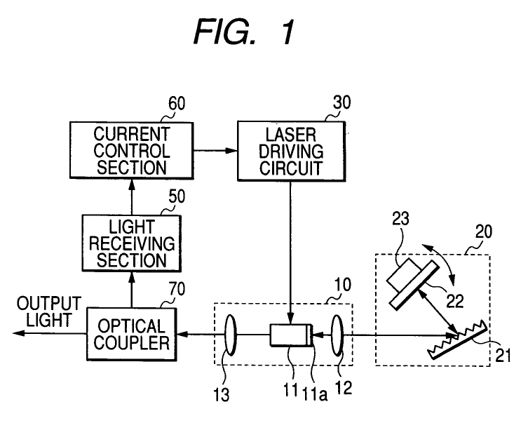

FIG. 1 is a diagram showing the configuration of a first embodiment of the invention. The components which are identical with those of FIG. 4 are denoted by the same reference numerals, and their description is omitted. Referring to FIG. 1, an optical coupler 70 is provided in place of the optical coupler 40 in FIG. 4. The optical coupler 70 is branches the laser light that is input from the semiconductor laser 11 via the second lens 13. The optical coupler 70 outputs one branched light as output light of the tunable laser source, and supplies the other branched light to the light receiving section 50.

The branch ratio of the optical coupler 70 is not constant in a predetermined wavelength range, i.e., the tunable range, and has wavelength characteristics which have a substantially inverted shape with respect to the wavelength characteristics of the light intensity of the laser light of the semiconductor laser 11. In the wavelength characteristics of the branch ratio of the optical coupler 70, namely, the light intensity ratio of the other branched light is smaller than that of the laser light output from the semiconductor laser 11.

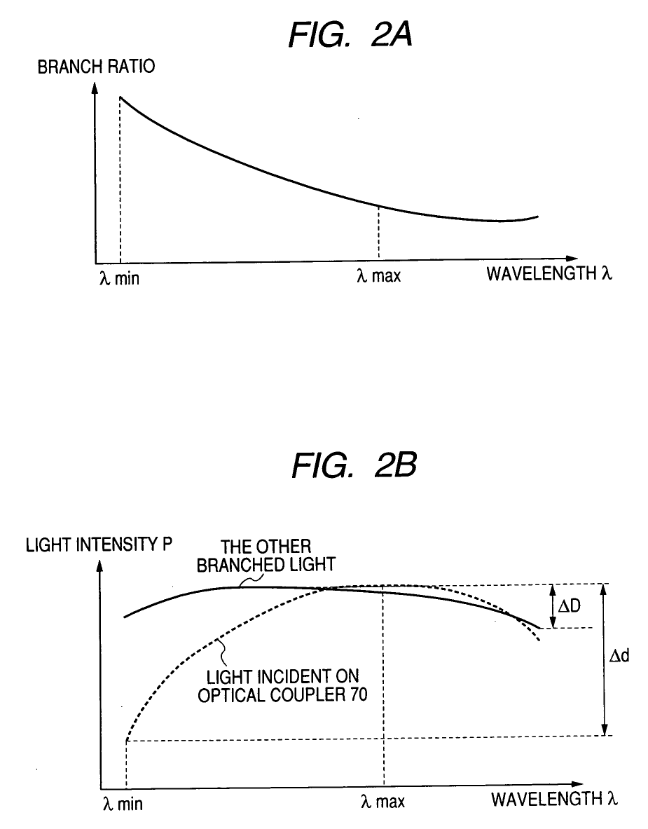

FIGS. 2A and 2B are views showing the wavelength characteristics of the branch ratio of the optical coupler 70, and that of the light intensity of the other branched light. In FIG. 2A, the abscissa indicates the wavelength, and the ordinate indicates the branch ratio (the light intensity of the other branched light/the light intensity of the one branched light). In FIG. 2B, the abscissa indicates the wavelength, and the ordinate indicates the light intensity which is normalized.

As shown in FIG. 2A, the branch ratio of the optical coupler 70 is larger in the shorter and longer wavelength sides of the tunable range (namely, the light intensity of the other branched light is large), and is small in the vicinity of the wavelength λmax (namely, the light intensity of the one branched light is large).

The operation of the above light source will be described.

The optical coupler 70 branches the laser light from the second lens into two light, outputs one branched light as the output light, and outputs the other branched light to the light receiving section 50. As shown in FIG. 2A, the optical coupler 70 branches a larger amount of the laser light toward the other side in the shorter and longer wavelength sides, and branches a larger amount of laser light toward the one side in the vicinity of the wavelength λmax.

As shown in FIG. 2B, therefore, the light intensity ratio ΔD of the other branched light is smaller than the light intensity ratio Δd of the laser light output from the semiconductor laser 11. Namely, the optical coupler 70 has wavelength characteristics in which, in the tunable range defined by the specification, the laser light is branched so that the light intensity ratio ΔD of the other branched light is smaller than a predetermined value. The operation of the optical coupler 70 is identical with that of the optical coupler shown in FIG. 4 except the operation that the branch ratio of the laser light is changed depending on the wavelength. Therefore, the description is omitted.

Since the branch ratio of the optical coupler 70 is different depending on the wavelength as described above, the light intensity ratio ΔD of the maximum light intensity of the other branched light incident on the light receiving section 50 and the minimum light intensity is smaller than the light intensity ratio Δd of the laser light incident on the optical coupler 70. As a result, the dynamic range required in the light receiving section 50 can be reduced, and the intensity of the other branched light can be accurately measured. Therefore, the current control section 60 can correctly obtain the laser driving current of the semiconductor laser 11, and accurately adjust the intensity of the output light.

### Second Embodiment

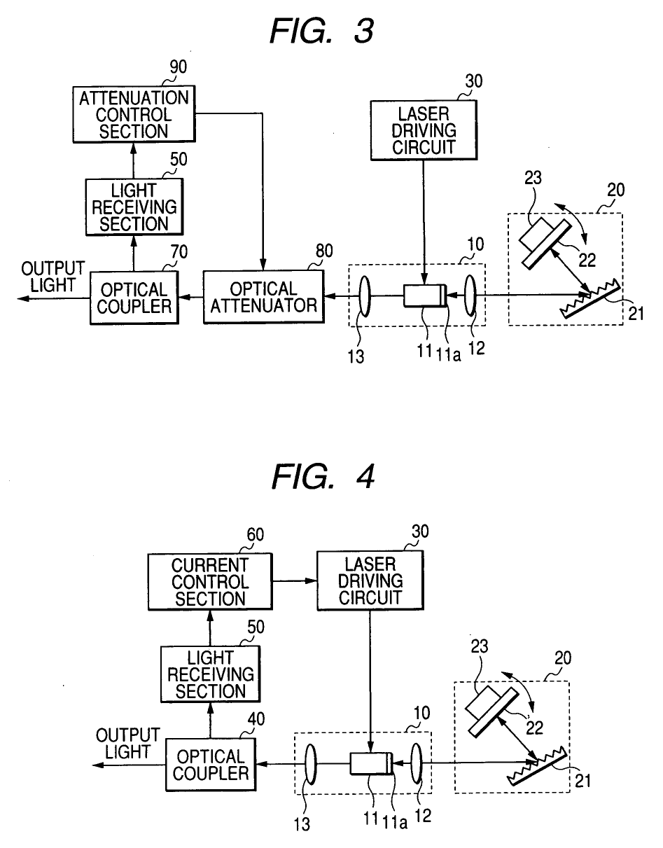

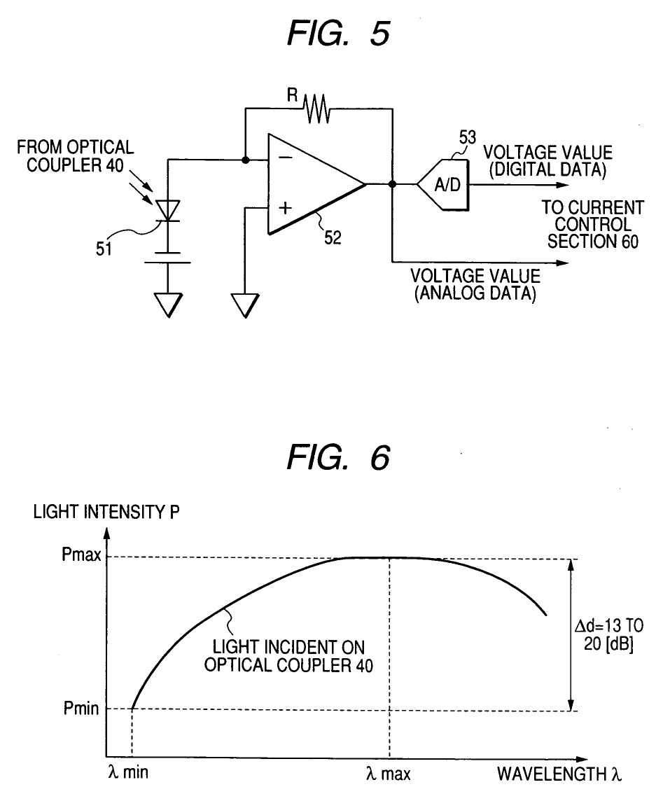

In the light source shown in FIG. 1, the configuration in which the intensity of the output light is adjusted by controlling the laser driving current of the semiconductor laser 11 has been described. Alternatively, the intensity of the output light is adjusted by attenuating the intensity of the laser light emitted from the semiconductor laser 11 (For example, see JP-A-2002-232075.). FIG. 3 is a diagram showing the configuration of a second embodiment of the invention. The components which are identical with those of FIG. 1 are denoted by the same reference numerals, and their description is omitted. Referring to FIG. 3, an optical attenuator 80 is disposed between the second lens and the optical coupler 70. In place of the current control section 60, an attenuation control section 90 is provided.

In accordance with instructions from the attenuation control section 90, the optical attenuator 80 attenuates the laser light emitted from the semiconductor laser 11, and supplies the attenuated laser light to the optical coupler 70. The attenuation control section 90 controls the degree of attenuation of the optical attenuator 80 on the basis of the intensity of the other branched light which is received by the light receiving section 50. Namely, the attenuation control section 90 is an APC.

The light source operates in an approximately same manner as the light source shown in FIG. 1 except the following operation. On the basis of the voltage value supplied from the light receiving section 50, the attenuation control section 90 obtains a degree of attenuation at which the intensity of the output light is a target value, and supplies it to the optical attenuator 80. As a result, the optical attenuator 80 attenuates the laser light of the semiconductor laser 11 by the obtained attenuation degree, and outputs the attenuated laser light to the optical coupler 70.

As described above, the branch ratio of the optical coupler 70 is different depending on the wavelength. Therefore, the light intensity ratio ΔD of the maximum light intensity of the other branched light incident on the light receiving section 50 and the minimum light intensity is smaller than the light intensity ratio Δd of the laser light incident on the optical coupler 70 via the optical attenuator 80. As a result, the dynamic range required in the light receiving section 50 can be reduced, and the intensity of the other branched light can be accurately measured. Therefore, the attenuation control section 90 can correctly obtain the degree of attenuation at which the optical attenuator 80 conducts attenuation, and accurately adjust the intensity of the output light.

The invention is not restricted to these embodiments, and may be configured in the following manner.

In the light sources shown in FIGS. 1 and 3, the configuration in which the optical coupler 70 is used as an example of the branch means has been described. Alternatively, a beam splitter on which a multilayer is formed, a half mirror, or the like may be used. In the alternative, it is preferable that the second lens 13 converts the laser light from the semiconductor laser 11 to parallel light, and then emits the light. In summary, any configuration is employed as far as it branches incident laser light, and reduces the light intensity ratio ΔD of the other branched light in a predetermined wavelength range to be smaller than the light intensity ratio Δd of the laser light output from the semiconductor laser 11.

In the light sources shown in FIGS. 1 and 3, the configuration in which an external resonator type tunable laser source in a Littman arrangement is used has been described. The external resonator may have any configuration. For example, only a mirror serving as a reflecting means is provided in the wavelength selecting section 20, and the mirror may be moved along the optical axis. Alternatively, only a diffraction grating serving as the reflecting means may be provided in the wavelength selecting section, and the diffraction grating may be moved along the optical axis. Furthermore, an internal resonator type tunable laser source may be used in place of an external resonator type one.

In the light sources shown in FIGS. 1 and 3, the example in which the wavelength characteristics of the laser light of the semiconductor laser 11 has a convex shape has been described. The wavelength characteristics may have any shape. For example, the wavelength characteristics may have a shape which is monotonously increased or decreased, or that in which increase and decrease are repeated. The branch ratio of the optical coupler 70 may have any wavelength characteristics as far as the light intensity ratio ΔD of the other branched light is smaller than the light intensity ratio Δd of the laser light output from the semiconductor laser 11.

What is claimed is:

1. A tunable laser source, comprising:
a semiconductor laser which outputs laser light over a predetermined wavelength range;
a laser driving circuit which supplies a laser driving current to the semiconductor laser;
a light receiving section which receives the laser light output from the semiconductor laser;
a current control section which controls the laser driving current output from the laser driving circuit based on a light intensity of the laser light received by the light receiving section; and
a branch section which branches the laser light output from the semiconductor laser to output one branched light as output light and output another branched light to the light receiving section,
wherein the branch section has wavelength characteristics of a branch ratio in the predetermined wavelength range where a light intensity ratio of the another branched light is smaller than a light intensity ratio of the laser light output from the semiconductor laser.

2. A tunable laser source, comprising:
a semiconductor laser which outputs laser light over a predetermined wavelength range;
a laser driving circuit which supplies a laser driving current to the semiconductor laser;
an optical attenuator which attenuates the laser light output from the semiconductor laser;
a light receiving section which receives the laser light attenuated by the optical attenuator;
an attenuation control section which controls attenuation by the optical attenuator based on a light intensity of the laser light received by the light receiving section; and
a branch section which branches the laser light output from the optical attenuator to output one branched light as output light and output another branched light to the light receiving section,
wherein the branch section has wavelength characteristics of a branch ratio in the predetermined wavelength range where a light intensity ratio of the another branched light is smaller than a light intensity ratio of the laser light output from the semiconductor laser.

3. The tunable laser source according to claim 1,
wherein the branch section is an optical coupler, a beam splitter, or a half mirror.

4. The tunable laser source according to claim 2,
wherein the branch section is an optical coupler, a beam splitter, or a half mirror.

5. The tunable laser source according to claim 1,
wherein, the semiconductor laser has wavelength characteristics of the light intensity of the laser light in the predetermined wavelength range where the light intensity decreases as a wavelength of the laser light shifts toward a shorter wavelength side and a longer wavelength side, and
the branch section has wavelength characteristics of the branch ratio in the predetermined wavelength range where the light intensity of the another branched light increases as the wavelength of the wavelength of the laser light shifts toward the shorter wavelength side and the longer wavelength side, and where the light intensity ratio of the another branched light is smaller than a predetermined value.

6. The tunable laser source according to claim 2,
wherein, the semiconductor laser has wavelength characteristics of the light intensity of the laser light in the predetermined wavelength range where the light intensity decreases as a wavelength of the laser light shifts toward a shorter wavelength side and a longer wavelength side, and
the branch section has wavelength characteristics of the branch ratio in the predetermined wavelength range where the light intensity of the another branched light increases as the wavelength of the wavelength of the laser light shifts toward the shorter wavelength side and the longer wavelength side, and where the light intensity ratio of the another branched light is smaller than a predetermined value.
